(19) United States
(12) Patent Application Publication
(10) Pub. No.: US 2012/0149847 A1
(43) Pub. Date: Jun. 14, 2012

(54) PROCESS FOR MAKING FUNCTIONALIZED POLYMERS

(75) Inventors: Steve Gregory COATS, Lewes, DE (US); Simona Percec, Philadelphia, PA (US); Susan H. Tilford, Ewing, NJ (US)

(73) Assignee: E. I. DU PONT DE NEMOURS AND COMPANY, Wilmington, DE (US)

(21) Appl. No.: 12/964,818

(22) Filed: Dec. 10, 2010

(51) Int. Cl. C08F 8/32; C08F 8/40

(52) U.S. Cl. 525/293; 525/327.6

(57) ABSTRACT

Disclosed herein is a process for making functionalized polymers comprising ethylene and substituted ethylene segments. The process comprises combining a starting copolymer as a solid with at least one amine-containing compound. The functionalized polymers are useful as film forming resins in cathodic electrocoating compositions.

### FIELD OF THE INVENTION

The invention relates to the field of electrocoating compositions. More specifically, the invention relates to a process for making functionalized polymers comprising ethylene and substituted ethylene segments for use in cathodic electrocoating compositions.

### BACKGROUND

The coating of electrically conductive substrates by an electrodeposition process, also called an electrocoating process, is a well-known and important industrial process. For example, electrodeposition of primers on metal automotive substrates is widely used in the automotive industry. In this process, a conductive article, such as an autobody or an auto part, is immersed in a bath of an aqueous emulsion of film forming polymer and the article acts as an electrode in the electrodeposition process. An electric current is passed between the article and a counter-electrode in electrical contact with the coating composition until a coating is deposited on the article. In a cathodic electrocoating process, the article to be coated is the cathode and the counter-electrode is the anode.

Film forming resin compositions used in the bath of a typical cathodic electrodeposition process also are well known in the art and have been in use since the 1970's. These resins typically are made from polyepoxide resins that have been chain extended with an amine compound(s). The epoxy amine adduct is then neutralized with an acid compound to form a water soluble or water dispersible resin. These resins are blended with a crosslinking agent, usually a polyisocyanate, and dispersed in water to form a water emulsion.

Currently, cathodic electrodeposition is the preferred method used by the automotive industry. However, there is still a need for improved electrocoating compositions that require lower baking temperatures, and result in coatings having improved UV stability and improved resistance to chipping.

### SUMMARY

The present invention addresses the above needs by providing a process for making novel functionalized polymers comprising ethylene and substituted ethylene segments which are useful in cathodic electrocoating compositions.

In one aspect, the invention is a process comprising the steps of:
a) providing as a solid, a polymer comprising:
   i) at least one ethylene segment of structure A

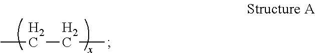

ii) at least one substituted ethylene segment of structure B

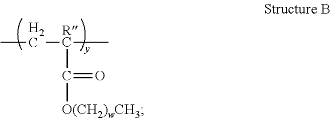

and
iii) at least one substituted ethylene segment of structure C

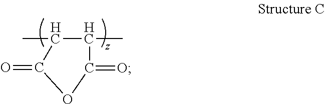

b) heating the polymer of (a) to a temperature sufficient to soften the polymer;
c) adding to the polymer of (b) at least one amine containing compound to form a mixture, said amine containing compound being selected from the group consisting of R′NH(CH₂)ₘN(CH₃)₂, R′NH(CH₂)ₙ—(CH═CH)—(CH₂)ᵣCH₃, R′NH(CH₂)ᵥCH₃, R′NH(CH₂)ₚOH, R′NH(CH₂)ₛN(CH₂CH₂OH)₂, R′NH(CH₂)ₜOPO₃H₂, and combinations thereof;
d) agitating and heating the mixture of (c) for a combination of time and temperature sufficient to form a functionalized polymer comprising:
   iv) at least one ethylene segment of structure 1

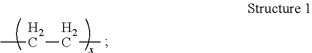

v) at least one substituted ethylene segment of structure 2

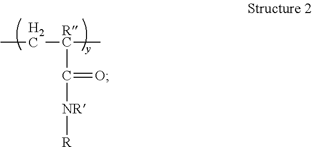

and
vi) at least one substituted ethylene segment of structure 3

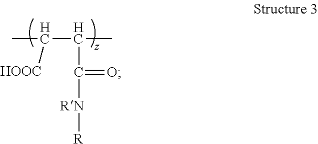

and
e) recovering the functionalized polymer of (d);
wherein: x and y are integers from 10 to 30,000 and z is an integer from 1 to 10;
   R′ is H, —C_{q}H_{2q+1} or —C_{q}H_{2q-k}; R″ is H or CH₃; and
   each R is independently at least one member selected from the group consisting of:
   —(CH₂)ₘN(CH₃)₂, —(CH₂)ₙ—(CH═CH)—(CH₂)ᵣCH₃, —(CH₂)ᵥCH₃, —(CH₂)ₚOH, —(CH₂)ₛN(CH₂CH₂OH)₂, and —(CH₂)ₜOPO₃H₂, where q, r, s, t, m, n, v, and p are independently selected from the group of integers from 1 to 20, w is an integer from 0 to 3, and k is the number of rings in —C_{q}H_{2q-hd k}.

### DETAILED DESCRIPTION

Disclosed herein is a method for making novel functionalized polymers, which are useful as film forming resins in cathodic electrocoating compositions. The polymers, which comprise ethylene and substituted ethylene segments, are functionalized to make them dispersible in water and to enable cathodic electrodeposition.

### Polymer Compositions

The functionalized polymers disclosed herein comprise:
a) at least one ethylene segment of structure 1;

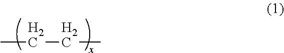

b) at least one substituted ethylene segment of structure 2;

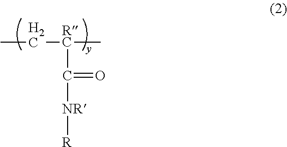

and
c) at least one substituted ethylene segment of structure 3;

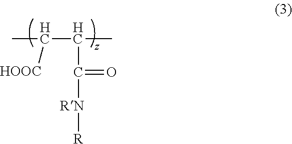

wherein: x and y are integers from 10 to 30,000 and z is an integer from 1 to 10; R′ is H, —C_{q}H_{2q+1} (alkyl) or —C_{q}H_{2q-k} (cycloalkyl); R″ is H or CH₃, and each R is independently at least one member selected from the group consisting of —(CH₂)ₘN(CH₃)₂, —(CH₂)ₙ—(CH═CH)—(CH₂)ᵣCH₃, —(CH₂)ᵥCH₃, —(CH₂)ₚOH, —(CH₂)ₛN(CH₂CH₂OH)₂, and —(CH₂)ₜOPO₃H₂, where q, r, s, t, m, n, v, and p are independently selected from the group of integers from 1 to 20, and k is the number of rings in —C_{q}H_{2q-k}.

In one embodiment, R′ is H, and R is —(CH₂)ₘN(CH₃)₂, —(CH₂)ₙ—(CH═CH)—(CH₂)ᵣCH₃, and —(CH₂)ₚOH in the substituted ethylene segment of structure 2 and in the substituted ethylene segment of structure 3.

In another embodiment, R′ is H, and R is —(CH₂)ₘN(CH₃)₂, —(CH₂)ₙ—(CH═CH)—(CH₂)ᵣCH₃, and —(CH₂)ₚOH in the substituted ethylene segment of structure 2 and in the substituted ethylene segment of structure 3, and m=3, n=8, r=7, and p=2.

In another embodiment, R′ is H, and R is —(CH₂)ₙ—(CH═CH)—(CH₂)ᵣCH₃ and —(CH₂)ₚOH in the substituted ethylene segment of structure 2 and in the substituted ethylene segment of structure 3.

In another embodiment, R′ is H, and R is —(CH₂)ₙ—(CH═CH)—(CH₂)ᵣCH₃ and —(CH₂)ₚOH in the substituted ethylene segment of structure 2 and in the substituted ethylene segment of structure 3, and n=8, r=7, and p=2.

In another embodiment, R′ is H, and R is —(CH₂)ₙ—(CH═CH)—(CH₂)ᵣCH₃ and —(CH₂)ₛN(CH₂CH₂OH)₂ in the substituted ethylene segment of structure 2 and in the substituted ethylene segment of structure 3.

In another embodiment, R′ is H, and R is —(CH₂)ₙ—(CH═CH)—(CH₂)ᵣCH₃ and —(CH₂)ₛN(CH₂CH₂OH)₂ in the substituted ethylene segment of structure 2 and in the substituted ethylene segment of structure 3 and n=8, r=7, and s=3.

In another embodiment, R′ is H, and R is —(CH₂)ₘN(CH₃)₂ and —(CH₂)ₚOH in the substituted ethylene segment of structure 2 and in the substituted ethylene segment of structure 3.

In another embodiment, R′ is H, and R is —(CH₂)ₘN(CH₃)₂ and —(CH₂)ₚOH in the substituted ethylene segment of structure 2 and in the substituted ethylene segment of structure 3 and wherein m=3, and p=2.

In another embodiment, R′ is —C_{q}H_{2q+1} and R is —(CH₂)ₚOH in the substituted ethylene segment of structure 2 and in the substituted ethylene segment of structure 3.

In another embodiment, R′ is —C_{q}H_{2q+1} and R is —(CH₂)ₚOH in the substituted ethylene segment of structure 2 and in the substituted ethylene segment of structure 3 and q=2 and p=2.

In another embodiment, R′ is H, and R is —(CH₂)ₜOPO₃H₂ in the substituted ethylene segment of structure 2 and in the substituted ethylene segment of structure 3.

In another embodiment, R′ is H, and R is —(CH₂)ₜOPO₃H₂ in the substituted ethylene segment of structure 2 and in the substituted ethylene segment of structure 3 and t=2.

The functionalized polymers disclosed herein may be prepared by chemical modification of random or block copolymers comprising ethylene, and substituted ethylene segments (i.e., acrylate alkyl ester, and maleic anhydride segments). Specifically, these random and block copolymers comprise:
i) at least one ethylene segment of structure A;

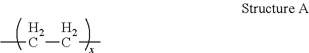

ii) at least one substituted ethylene segment of structure B;

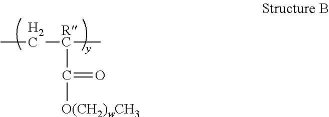

and
iii) at least one substituted ethylene segment of structure C;

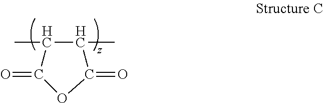

wherein: x and y are integers from 10 to 30,000, z is an integer from 1 to 10, w is an integer from 0 to 3, and R″ is H or CH₃.

In some embodiments, the copolymer comprises about 15 to 59.5 wt % (percent by weight) of structure A, about 40 to 75 wt % of structure B, and about 0.5 to 10 wt % of structure C. In other embodiments, the copolymer comprises about 25 to 49.5 wt % of structure A, about 50 to 70 wt % of structure B, and about 0.5 to 5 wt % of structure C.

Suitable copolymers comprising these segments may be prepared using methods known in the art. For example, the copolymers may be prepared by free radical-initiated emulsion polymerization, or bulk or solution polymerization in the presence of organic hydroperoxides, peroxides, diazo compounds, or the like (see for example, Greene, U.S. Pat. No. 3,904,588; and Wu et al., U.S. Pat. No. 7,608,675). As an alternative to preparing the starting copolymer, Vamac® ethylene acrylic elastomers, sold by E. I. du Pont de Nemours and Co. (Wilmington, Del.), can be used.

The functionalized polymers disclosed herein can be prepared by reacting the starting copolymer with various primary or secondary amine containing-compounds. Suitable amine-containing compounds include, but are not limited to, R′NH(CH₂)ₘN(CH₃)₂, R′NH(CH₂)ₙ—(CH═CH)—(CH₂)ᵣCH₃, R′NH(CH₂)ᵥCH₃, R′NH(CH₂)ₚOH, R′NH(CH₂)ₛN(CH₂CH₂OH)₂, and R′NH(CH₂)ₜOPO₃H₂, where R′ is H, —C_{q}H_{2q+1} (alkyl) or —C_{q}H_{2q-k} (cycloalkyl), and q, r, s, t, m, n, v, and p are independently selected from the group of integers from 1 to 20 and k is the number of rings in C_{q}H_{2q-k}. Combinations of two or more amine-containing compounds may be used.

In one embodiment, a combination of oleylamine, 3-dimethyl-1-propylamine, and ethanolamine is used to functionalize the starting copolymer.

In another embodiment, a combination of oleylamine and N-(3-aminopropyl)diethanolamine is used to functionalize the starting copolymer.

In another embodiment, a combination of ethanolamine and 3-dimethyl-1-propylamine is used to functionalize the starting copolymer.

In another embodiment, 2-(ethylamino)ethanol is used to functionalize the starting copolymer.

In another embodiment, a combination of oleylamine and ethanolamine is used to functionalize the starting copolymer.

The functionalized polymer can be prepared by combining the starting copolymer with at least one amine-containing compound and a suitable catalyst in a solvent, such as methyl isobutyl ketone, diisobutyl ketone, methyl ethyl ketone, toluene, xylene, trichloroethylene, dichlorobenzene, and mixtures thereof. Suitable catalysts include, but are not limited to, diazabicylco[2.2.2]octane, tertiary amines, hindered secondary amines, and bifunctional derivatives such as imidazoles and 8-hydroxyquinoline. The resulting mixture is stirred for a time sufficient to obtain the desired degree of functionalization. The reaction mixture may be heated to increase the rate of reaction. The mixture may be further heated to remove volatile components and the fuctionalized polymer may be recovered using methods known in the art, such as precipitation. The degree of functionalization of the product can be determined using methods known in the art, such as infrared (IR) spectrometry, proton nuclear magnetic resonance (¹H NMR) spectroscopy, and carbon nuclear magnetic resonance (¹³C NMR) spectroscopy. In one embodiment, the degree of functionalization is at least 10 mol %.

The functionalized polymer may also be prepared using a batch kneading process. In this embodiment, the reaction is conveniently carried out in a kneader/reactor. Suitable kneader/reactors are known in the art and are available from companies such as LIST AG (Arisdorf, Switzerland). Kneader/reactors are specifically designed to handle highly viscous, sticky, and pasty materials as they provide intensive mixing and kneading action, referred to herein as “agitation”. Kneader/reactors typically are made of stainless steel, are jacketed for temperature control, and have ports for introducing polymer and other reactants, application of vacuum, and introducing purge gases. Agitation in the kneader/reactor is typically accomplished by means of impellers and hooks/baffles which are attached to the walls of the kneader/reactor.

The starting polymer comprising structures A, B, and C, as defined above, is provided as a solid, for example in a kneader/reactor, and then is heated to a temperature sufficient to soften the polymer. The temperature needed is dependent on the particular polymer used and is readily determined by one skilled in the art using routine experimentation. Typically for the polymers disclosed herein, the temperature is in the range of about 70° C. to about 100° C. Then, at least one amine-containing compound, as described above, is added to the softened polymer to form a mixture. In this embodiment, the use of a catalyst is optional; a catalyst is not required. If a catalyst is used, one may be chosen from those listed above. The mixture is agitated and heated for a combination of time and temperature sufficient to form a functionalized polymer comprising structures 1, 2, and 3, as defined above. Typically, the mixture is agitated and heated at a temperature of about 100° C. to about 270° C., more particularly, about 100° C. to about 125° C. Generally, shorter reaction times are used at higher temperatures, as is known in the art. In one embodiment, the mixture is heated to a temperature of about 100° C. to about 125° C. for 4 to 6 hours. Then, the resulting functionalized polymer is recovered, e.g., removed from the kneader/reactor by opening a bottom drain valve and applying pressure with an inert gas, such as nitrogen, above the polymer so that it will flow out of the kneader/reactor.

For large scale production, the functionalized polymer may be prepared in a continuous process using a continuous kneader or extruder.

### Aqueous Dispersion Composition

An aqueous dispersion of the functionalized polymers disclosed herein can be prepared by adding the functionalized polymer to water and adjusting the pH to about 5.0 to 7.0, more particularly, about 6.0 to 7.0, and more particularly, about 6.5 to 7.0, with the addition of an acid. Suitable acids include, but are not limited to, acetic acid, sulfonic acid, formic acid, phosphoric acid, and fatty acids, such as lauryl acid. The term “aqueous dispersion”, as used herein, refers to a two-phase system in which solid particles are dispersed in an aqueous solution. The dispersing agent for the disclosed functionalized polymers is water; however, small amounts of volatile organic solvents may be present. Typically, the aqueous dispersion comprises about 5% to about 50% by weight of the functionalized polymer. The resulting mixture is stirred using methods and apparatus known in the art, such as stirred tanks, stirred mills, static mixers, and the like. The mixture may be heated to aid in the formation of the dispersion.

The aqueous dispersion can also be prepared using a phase inversion process, wherein the functionalized polymer is first dissolved in an organic solvent, such as methyl isobutyl ketone. The resulting solution is then poured into an acidified aqueous solution having a pH of about 5.0 to 7.0, more particularly, about 6.0 to 7.0, and more particularly, about 6.5 to 7.0, with high speed mixing. The methyl isobutyl ketone is removed using methods known in the art, such as evaporation, to yield the aqueous dispersion.

The aqueous dispersion may further comprise at least one crosslinking agent. Suitable crosslinking agents are known in the art, and include, but are not limited to, blocked isocyanates, melamine-formaldehyde resins, tris(alkoxycarbonyl-amino)triazines, alkoxysilanes, and polyepoxides. In some embodiments, a blocked isocyanate crosslinking agent is used. Isocyanate crosslinking agents and blocking agents are well known in the art (see for example Wismer et al., U.S. Pat. No. 4,419,467). Suitable isocyanate crosslinking agents include, but are not limited to, aliphatic, cycloaliphatic and aromatic isocyanates such as hexamethylene diisocyanate, cyclohexylene diisocyanate, tolylene-2,4-diisocyanate, 4,4′-methylene diphenyl diisocyanate, and the like. These isocyanates are pre-reacted with a blocking agent such as oximes, alcohols, or caprolactams which block the isocyanate functionality, i.e., the crosslinking functionality. Upon heating the blocking agents dissociate, thereby providing a reactive isocyanate group and crosslinking occurs. In some embodiments, the blocked isocyanate crosslinking agent is an alcohol blocked, methylene diphenyl diisocyanate, as described by Gam (U.S. Pat. No. 6,207,731). In some embodiments, the crosslinking agent is an alkoxysilane, such as 3-(isocyanatopropyl)triethoxysilane. The aqueous dispersion generally contains about 10% to about 50%, more particularly, about 30% to about 40% by weight of the functionalized polymer and the crosslinking agent. The aqueous dispersion may be further diluted with water when added to an electrocoating bath to give a range of about 10% to about 30% by weight of the functionalized polymer and the crosslinking agent.

The aqueous dispersion may further comprise other optional additives, if desirable. Optional additives can include, for example, surfactants, pigments, light stabilizers, anti-crater agents, flow aids, dispersion stabilizers, adhesion promoters, corrosion inhibitors, and fillers.

Examples of surfactants include alkoxylated styrenated phenols, such as, for example, SYNFAC® 8334, available from Milliken Chemical Company, Spartanburg, S.C.; alkyl imidazoline surfactants; and nonionic surfactants such as, for example, SURFYNOL® surfactants, available from Air Products, Allentown, Pa. Combinations of surfactants can also be used.

The aqueous dispersion may also comprise at least one pigment. Pigments for use herein may be selected from color pigments, effect pigments, electrically conductive pigments, magnetically shielding pigments, extender pigments, and anti-corrosion pigments. Examples of useful pigments include, but are not limited to, titanium dioxide, ferric oxide, red iron oxide, transparent red iron oxide, black iron oxide, brown iron oxide, chromium oxide green, carbon black, aluminum silicate, precipitated barium sulfate and combinations thereof.

Light stabilizers, such as, for example, hindered amine light stabilizers can be added to the aqueous dispersion composition. Representative commercially available hindered amine light stabilizers can be, for example, TINUVI N® 770, 292 and 440 which are sold by Ciba Specialty Chemicals Corporation.

The aqueous dispersion composition may also comprise at least one anti-crater agent. Anti-crater agents are well known in the art; examples are given by Chung (U.S. Pat. No. 5,789,468), Gam (U.S. Pat. Nos. 5,908,910, and 6,207,731), and Gam et al. (U.S. Pat. No. 7,264,706).

Flow aids include materials such as, for example, ethylene and/or propylene adducts of nonyl phenols or bisphenols.

### Process for Coating a Substrate

The aqueous dispersion disclosed herein can be used in a conventional cathodic electrocoating process to coat a substrate. Accordingly, in one embodiment, the invention provides a process for coating a substrate comprising the steps of:
(a) providing an electrochemical cell comprising:
   (i) an aqueous dispersion as described above;
   (ii) a substrate to be coated, wherein the substrate is in contact with the aqueous dispersion and the substrate serves as a cathode of the electrochemical cell;
   (iii) an anode in contact with the aqueous dispersion; and
   (iv) a power supply in electrical contact with the anode and cathode; and
(b) applying a voltage between the cathode and the anode to electrodeposit a polymer coating onto at least a portion of the substrate.

In one embodiment, the substrate is partially immersed in the aqueous dispersion. In another embodiment, the entire substrate is immersed in the aqueous dispersion.

Useful substrates that can be coated using the process disclosed herein are electrically conductive substrates including, but not limited to, metallic materials, for example ferrous metals such as iron, steel, and alloys thereof, non-ferrous metals such as aluminum, zinc, magnesium and alloys thereof, and combinations thereof. In some embodiments, the substrate is cold-rolled steel, zinc-coated steel, aluminum or magnesium.

The voltages that are applied in the process vary depending on the type of coating and on the coating thickness desired and may be as low as 1 volt or as high as several thousand volts. Typical voltages used are between 50 to 500 volts. The current density can vary in the range from 1 ampere per square meter to 150 amperes per square meter. The process is typically carried out at a temperature between 25° C. to about 40° C. The time required for the process will vary depending on the desired thickness of the polymer coating.

After the polymer coating has been deposited onto the substrate, the resulting coated substrate is removed from the aqueous dispersion. The coated substrate can optionally be rinsed and then the polymer coating is cured by baking at elevated temperature, such as 150 to 250° C., for a time sufficient to cure the coating. Heating may be done using any means known in the art, such as heating in a baking oven, with a bank of infrared lamps, or a combination thereof.

The thickness of the dried and cured polymer coating is typically between 12 to 50 microns, more particularly, between 15 to 45 microns.

The substrate that is coated with the dried and cured polymer coating can be used as is or additional layers of coating compositions can be applied thereon. In the manufacture of automobiles and other consumer goods, the cured polymer coating can be further coated with one or more of commercially available primers, primer surfacers, sealers, basecoat compositions, clearcoat compositions, glossy topcoat compositions and any combination thereof.

The coated substrates can be various articles used as components to fabricate automotive vehicles, automobile bodies, any and all items manufactured and painted, such as, for example, frame rails, commercial trucks and truck bodies, including but not limited to, beverage truck bodies, utility truck bodies, ready mix concrete delivery vehicle bodies, waste hauling vehicle bodies, and fire and emergency vehicle bodies, as well as any potential attachments or components to such truck bodies, buses, farm and construction equipment, truck caps and covers, commercial trailers, consumer trailers, recreational vehicles, including but not limited to, motor homes, campers, conversion vans, vans, pleasure vehicles, pleasure craft, snow mobiles, all terrain vehicles, personal watercraft, motorcycles, boats, and aircraft. The substrate further includes industrial and commercial new construction components; walls of commercial and residential structures, such as office buildings and homes; amusement park equipment; marine surfaces; outdoor structures, such as bridges, towers; coil coating; railroad cars; machinery; OEM tools; signage; sporting goods; and sporting equipment. The substrates can have any shape, for example, in the form of automotive body components, such as bodies (frames), hoods, doors, fenders, bumpers and/or trim, for automotive vehicles.

### EXAMPLES

The present invention is further defined in the following Examples. It should be understood that these Examples, while indicating preferred embodiments of the invention, are given by way of illustration only. From the above discussion and these Examples, one skilled in the art can ascertain the essential characteristics of this invention, and without departing from the spirit and scope thereof, can make various changes and modifications of the invention to adapt it to various uses and conditions.

The meaning of abbreviations used is as follows: “min” means minute(s), “hr” means hour(s), “sec” means second(s), “L” means liter(s), “mL” means milliliter(s), “μL” means microliter(s), “g” means gram(s), “mg” means milligram(s), “μg” means microgram(s), “mol” means mole(s), “mmol” means millimole(s), “cm” means centimeter(s), “mm” means millimeter(s), “μm” means micrometer(s), “mils” means thousandths of an inch, “M” means molar concentration, “wt %” means percent by weight, “V” means volt(s), “rpm” means revolutions per minute.

### Reagents

Vamac® G ethylene acrylic elastomer was obtained from E. I. du Pont de Nemours and Co. (Wilmington, Del.). All other reagents were obtained from Sigma-Aldrich (St Louis, Mo.) unless otherwise noted.

### Example 1

### Reaction of Vamac® G with Oleylamine and Ethanolamine Using a Batch Kneading Process in a Kneader/Reactor

This Example demonstrates the use of a batch kneading process to graft Vamac® G ethylene acrylic elastomer with a mixture of oleylamine and ethanolamine. The reaction was carried out in a 3.0-L kneader/reactor (manufactured by LIST AG; Arisdorf, Switzerland). The reactor is made from grade 316 stainless steel and has a working volume of 2.0 L. The reactor has a jacket which can be supplied with hot oil to heat the reactor's contents up to a temperature of 270° C. The reactor is insulated to minimize heat losses. The reactor contains a 2 inch (5.0 cm) diameter port to allow addition of polymer and other ingredients, the application of vacuum, and purge gas, and a bottom drain port to empty the reactor. The reactor contains an agitator with a central shaft of approximately 1 inch (2.5 cm) diameter with three sets of impellers which protrude in both the axial and radial directions. These impellers intermesh with four sets of stationary hooks/baffles attached to the reactor wall. The moving agitator and stationary baffles provide intensive mixing and kneading action and significant renewal of surface area to enhance grafting reactions and devolatilization of reaction gas/vapor byproducts. The agitator can be turned at speeds ranging from 8 to 56 rpm.

Vamac® G ethylene acrylic elastomer (300 g) was cut into ½ inch (1.3 cm) pieces and placed in the kneader/reactor. The polymer was heated at 70° C. under nitrogen for 50 min and agitated at 8-40 rpm to soften it. A mixture of ethanol amine (1.15 mol, 70.3 g) and oleylamine (1.15 mol, 307.0 g) was added using a high pressure syringe pump (Teledyne Isco, Inc., Lincoln, Nebr.) at a rate of 20 mL/min. The agitation was increased to 56 rpm and the temperature was increased to 110±4° C., and the reactor was purged with nitrogen at 2 L/min. The components were mixed for 3 hr and 20 min at 110±4° C. and 16-56 rpm agitator speed until no separate liquid phase remained in the reactor and the viscosity of the melt had increased. Mixing continued at 123±2° C. for an additional 2.5 hours at 8 rpm. The resulting grafted polymer A was drained from the reactor at 123° C.

Formation of grafted polymer A was verified using ¹³C and ¹H NMR, and IR spectroscopic methods. For the IR analysis, the decrease in intensity of the C═O peak at 1738 cm⁻¹ and the appearance of amide peaks at 3300 and 1660 cm⁻¹ were used to confirm the formation of the functionalized polymer.

### Example 2

### Reaction of Vamac® G with Oleylamine and Ethanolamine Using a Batch Kneading Process in a Kneader/Reactor

The reaction was carried out in the kneader/reactor described in Example 12. Vamac® G ethylene acrylic elastomer (500 g) was cut into ¼-½ inch (0.6-1.3 cm) pieces and placed in the kneader/reactor. The polymer was heated at 70° C. under nitrogen for 50 min and a mixture of ethanol amine (1.92 mol, 117.0 g) and oleylamine (1.92 mol, 512.5 g) was added using a high pressure syringe pump (Teledyne Isco, Inc.) at a rate of 100 mL/min. The mixture was agitated at 8-32 rpm and the temperature was slowly increased to 110±4° C. over 1 hr under nitrogen. The components were mixed for 1 hr and 15 min at 110±4° C. and 8-56 rpm and the reactor was purged with nitrogen at 0.5 L/min. Mixing continued at 120±1° C. for an additional 2 hours at 8-32 rpm. Agitation was stopped and the reactor was slowly cooled to room temperature overnight under nitrogen. The resulting grafted polymer B was removed from the reactor at room temperature.

Formation of grafted polymer B was verified using ¹³C and ¹H NMR, and IR spectroscopic methods. For the IR analysis, the decrease in intensity of the C═O peak at 1738 cm⁻¹ and the appearance of amide peaks at 3300 and 1660 cm⁻¹ were used to confirm the formation of the functionalized polymer.

What is claimed is:

1. A process comprising the steps of:
a) providing as a solid, a polymer comprising:
i) at least one ethylene segment of structure A 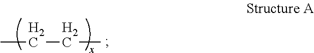
ii) at least one substituted ethylene segment of structure B 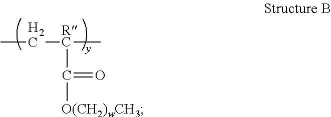
and
iii) at least one substituted ethylene segment of structure C 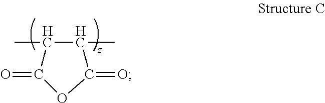
b) heating the polymer of (a) to a temperature sufficient to soften the polymer;
c) adding to the polymer of (b) at least one amine containing compound to form a mixture, said amine containing compound being selected from the group consisting of R′NH(CH₂)ₘN(CH₃)₂, R′NH(CH₂)ₙ—(CH═CH)—(CH₂)ᵣCH₃, R′NH(CH₂)ᵥCH₃, R′NH(CH₂)ₚOH, R′NH(CH₂)ₛN(CH₂CH₂OH)₂, R′NH(CH₂)ₜOPO₃H₂, and combinations thereof;
d) agitating and heating the mixture of (c) for a combination of time and temperature sufficient to form a functionalized polymer comprising:
iv) at least one ethylene segment of structure 1; 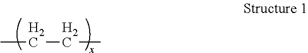
v) at least one substituted ethylene segment of structure 2; 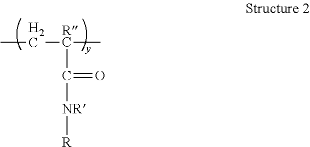
and
vi) at least one substituted ethylene segment of structure 3; 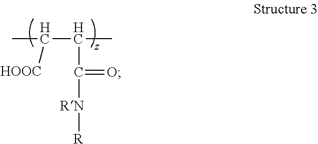
and
e) recovering the functionalized polymer of (d);
wherein: x and y are integers from 10 to 30,000 and z is an integer from 1 to 10;
R′ is H, —C_{q}H_{2q+1} or —C_{q}H_{q-k}; R″ is H or CH₃; and
each R is independently at least one member selected from the group consisting of:
—(CH₂)ₘN(CH₃)₂, —(CH₂)ₙ—(CH═CH)—(CH₂)ᵣCH₃, —(CH₂)ᵥCH₃, —(CH₂)ₚOH, —(CH₂)ₛN(CH₂CH₂OH)₂, and —(CH₂)ₜOPO₃H₂, where q, r, s, t, m, n, v, and p are independently selected from the group of integers from 1 to 20, w is an integer from 0 to 3, and k is the number of rings in —C_{q}H_{q-k}.

2. The process of claim 1, wherein R′ is H, and R is —(CH₂)ₘN(CH₃)₂, —(CH₂)ₙ—(CH═CH)—(CH₂)ᵣCH₃, and —(CH₂)ₚOH in the at least one substituted ethylene segment of structure 2 and the at least one substituted ethylene segment of structure 3.

3. The process according to claim 2 wherein m=3, n=8, r=7, and p=2.

4. The process according to claim 1, wherein R′ is H, and R is —(CH₂)ₙ—(CH═CH)—(CH₂)ᵣCH₃, and —(CH₂)ₚOH in the at least one substituted ethylene segment of structure 2 and the at least one substituted ethylene segment of structure 3.

5. The process according to claim 4 wherein n=8, r=7, and p=2.

6. The process according claim 1, R′ is H, and R is —(CH₂)ₙ—(CH═CH)—(CH₂)ᵣCH₃, and —(CH₂)ₛN(CH₂CH₂OH)₂ in the at least one substituted ethylene segment of structure 2 and the at least one substituted ethylene segment of structure 3.

7. The process according to claim 6 wherein n=8, r=7, and s=3.

8. The process according to claim 1, wherein R′ is H, and R is —(CH₂)ₘN(CH₃)₂, and —(CH₂)ₚOH in the at least one substituted ethylene segment of structure 2 and the at least one substituted ethylene segment of structure 3.

9. The process according to claim 8 wherein m=3, and p=2.

10. The process according to claim 1, wherein R′ is —C_{q}H_{2q+1}, and R is —(CH₂)ₚOH in the at least one substituted ethylene segment of structure 2 and the at least one substituted ethylene segment of structure 3.

11. The process according to claim 10 wherein q=2 and p=2.

12. The process according claim 1, wherein R′ is H, and R is —(CH₂)ₜOPO₃H₂ in the at least one substituted ethylene segment of structure 2 and the at least one substituted ethylene segment of structure 3.

13. The process according to claim 12 wherein t=2.

14. The process according to claim 1, wherein in step (b) the polymer is heated to a temperature of about 70° C. to about 100° C.

15. The process according to claim 1, wherein in step (d) the mixture is heated at a temperature of about 100° C. to about 270° C. for a time sufficient to form the functionalized polymer.

16. The process according to claim 1, wherein in step (d) the mixture is heated at a temperature of about 100° C. to about 125° C. for 4 to 6 hours.

17. The process according to claim 1, wherein the process is carried out in a kneader or extruder.
